(19) United States
(12) Patent Application Publication
(10) Pub. No.: US 2004/0268346 A1
(43) Pub. Date: Dec. 30, 2004

(54) Method for controlling loading operation of operation program onto mobile terminal

(75) Inventor: Sung-Woo Jun, Anyang (KR)

Correspondence Address: FLESHNER & KIM, LLP, P.O. BOX 221200, CHANTILLY, VA, 20153, US

(73) Assignee: LG Electronics Inc.

(21) Appl. No.: 10/873,264

(22) Filed: Jun. 23, 2004

(30) Foreign Application Priority Data
Jun. 24, 2003 (KR) 41267/2003

(51) Int. Cl. G06F 9/445

(52) U.S. Cl. 717/177

(57) ABSTRACT

A method for loading an operation program onto a mobile terminal, which includes comparing a first security code of the operation program provided by a communications company for operating the mobile terminal with a second security code of a downloading program used for downloading the operation program onto the mobile terminal, and determining whether or not a loading operation for loading the operation program onto the mobile terminal is legal based on the comparison of the first and second security codes.

### CROSS-REFERENCE TO A RELATED APPLICATION

This application relates to Korean Application No. 41267/2003, filed on Jun. 24, 2003, the entire contents of which is hereby incorporated in its entirety.

### BACKGROUND OF THE INVENTION

1. Field of the Invention

The present invention relates to a mobile terminal, and more particularly to a method for preventing someone from illegally downloading an operational program onto a mobile terminal.

2. Discussion of the Background Art

Currently, to download an operation program onto a mobile terminal, the mobile phone is connected to a Personal Computer (PC), for example, and the operation program is then downloaded. However, it is possible for a user other than an authorized user to download files onto the mobile terminal. For example, if the mobile terminal is lost or stolen, a person not authorized by the telecommunication provider could load a desired operational program onto the terminal. Further, because the operational programs existing on the mobile terminal are written in the “C” programming language, it is possible for someone to easily modify an existing operational program or add a new operational program onto the mobile terminal. The illegally modified mobile terminal may then be used.

### SUMMARY OF THE INVENTION

Accordingly, one object of the present invention is to address at least the above-noted and other problems.

Another object of the present invention is to prevent someone from illegally downloading or modifying an operational program onto a mobile terminal.

To achieve these and other advantages and in accordance with the purpose of the present invention as embodied and broadly described herein, the present invention provides a novel method for loading an operation program onto a mobile terminal, which includes comparing a first security code of the operation program for operating the mobile terminal with a second security code of a downloading program used for downloading the operation program onto the mobile terminal, and determining whether or not a loading operation for loading the operation program onto the mobile terminal is legal based on the comparison of the first and second security codes.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will now be described in detail with reference to the following drawings wherein:

FIG. 1 is a flow diagram showing a method for loading an operation program onto a mobile terminal;

FIG. 2 is an overview illustrating a computer system used in downloading an operation program onto a mobile terminal; and

FIG. 3 is a flow chart illustrating a method of downloading an operation program onto a mobile terminal according to the present invention.

### BEST MODE OF THE INVENTION

FIG. 1 is a flow diagram illustrating a method of downloading an operation program or file onto a mobile terminal. As shown, prior to loading the operation program onto the mobile terminal, the terminal information stored in the nonvolatile memory is backed-up (i.e., transferred) onto a PC, for example (steps S1 and S2). Next, the PC informs the terminal to prepare for a download operation (step S3), and the terminal responds to this request (step S4). Then, the PC downloads the operation program onto the terminal (step S5), and the terminal sends a result of the downloading operation to the PC (step S6). Finally, the information transferred from the nonvolatile memory of the terminal is restored onto the mobile terminal (steps S7 and S8).

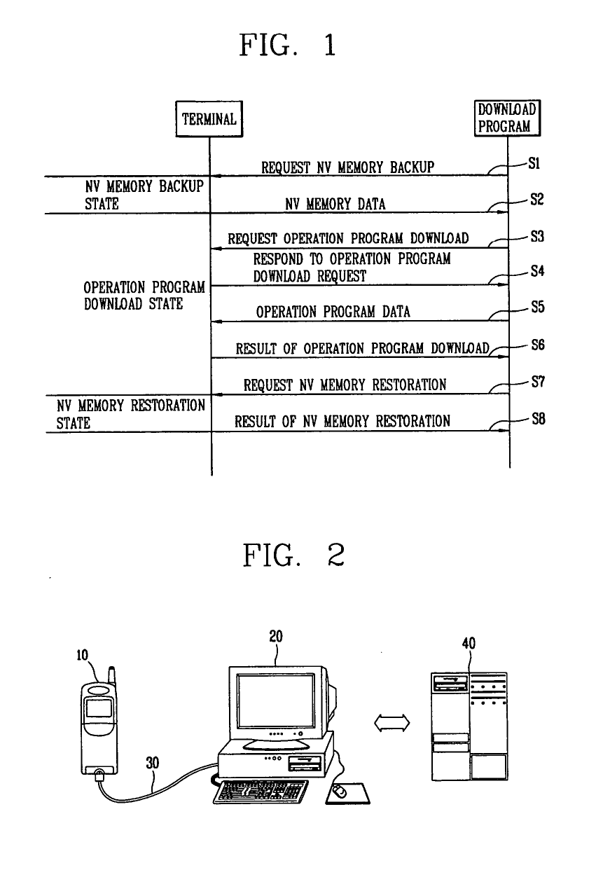

Next, FIG. 2 is an overview illustrating a terminal 10 on which an operation program is to be loaded; a personal computer (PC) 20 for installing an operation program from a mobile communication company, for example, on the terminal 10; and a terminal connector 30 for connecting the terminal 10 and the PC 20. Also shown is a server 40 for transferring installation information, other required data, etc. and the operation program to the PC 20. Further, the PC 20 includes a download program from a mobile communication company, for example, for downloading and installing an operation program on the terminal 10. In addition, the operation program is installed on an internal EEPROM (Electrically Erasable Programmable Read-Only Memory) such as a nonvolatile memory (NV memory).

Further, the terminal connector 20 may be connected to connection terminals of external devices, such as the input/output terminals of the terminal 10, the universal serial bus (USB) terminal of the PC 20 etc, to thereby transfer various data and signals to the terminal 10 from the PC 20.

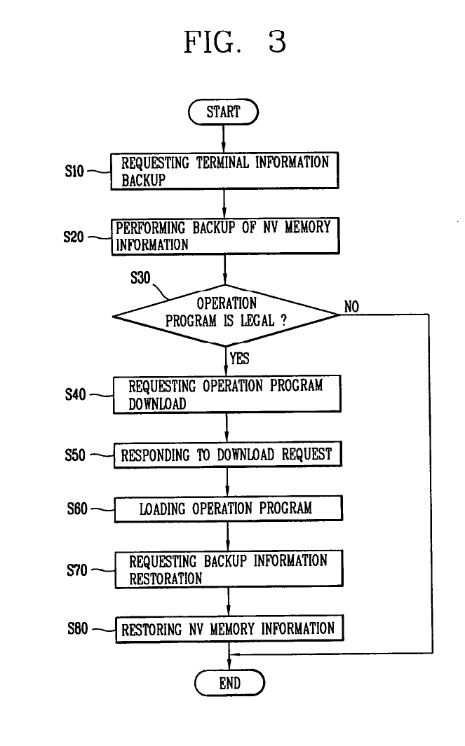

Further, in addition to the steps shown in FIG. 1, before the operation program is installed on the terminal 10, a protection code of the operation program sent from the mobile communications company and a protection code of the download program on the PC 20 are compared to determine whether or not the terminal operation program is legal. This additional feature will now be discussed in more detail with reference to FIG. 3, which is a flow chart illustrating a downloading operation of the operation program.

In more detail, the download program on the PC 20 requests the terminal 10 to backup the information data stored in the memory of the terminal (step S10). The terminal 10 then backups the data by sending information stored in its internal non-volatile memory to the downloaded program on the PC 20 and deletes the data in the internal non-volatile memory, thereby creating free space in the memory. Then, as noted above, before installing the operation program onto the terminal 10, the download program on the PC 20 determines whether or not the operation program is legal (step S30). This step may be performed by comparing a protection code of the download program on the PC 20 and a protection code of the operation program to be loaded on the terminal.

If the protection code of the download program and the protection code of the operation program are the same (Yes in step S30), the operation program is determined to be legal. If the two codes are not the same (No in step S30), the operation program is determined to be illegal and the download process is stopped. The mobile communications company may also be informed about the illegal attempt to change or download an operation program on the terminal. If the operation program is determined to be legal (Yes in step S30), the download program initiates an operation program download request to inform the terminal to be prepared to receive the operation program (step S40). The terminal 10 then notifies the PC 10 it is ready to receive the program (step S50). Then, the download program on the PC 20 transfers the data required for installing the operation program on the terminal 10, and the operation program is loaded and installed on the terminal 10 (step S60).

After the operation program has been loaded onto the terminal 10, the terminal 10 notifies the download program on the PC 20, the loading operation has been completed. The download program on the PC 20 then informs the terminal 10 that a restoring process is going to begin (step S70) and restores the backup information onto the terminal 10 (step S80). The terminal 10 then restores the backup information to its internal NV memory (step S80).

Thus, according to the present invention, it is possible to prevent someone from illegally changing or downloading an operation program onto a mobile terminal. The operation program is for operating the mobile terminal and is provided by a communication provider, for example. The program allows the user to use the terminal.

This invention may be conveniently implemented using a conventional general purpose digital computer or microprocessor programmed according to the teachings of the present specification, as well be apparent to those skilled in the computer art. Appropriate software coding can readily be prepared by skilled programmers based on the teachings of the present disclosure, as will be apparent to those skilled in the software are. The invention may also be implemented by the preparation of application specific integrated circuits or by interconnecting an appropriate network of conventional component circuits, as will be readily apparent to those skilled in the art.

The present invention includes a computer program product which is a storage medium including instructions which can be used to program a computer to perform a process of the invention. The storage medium can include, but is not limited to, any type of disk including floppy disks, optical discs, CD-ROMs, and magneto-optical disks, ROMs, RAMs, EPROMs, EEPROMs, magnetic or optical cards, or any type of media suitable for storing electronic instructions

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method for loading an operation program onto a mobile terminal, comprising:
determining whether or not a loading operation for loading an operation program onto the mobile terminal is legal.

2. The method of claim 1, further comprising:
backing-up operation program related information originally stored on the terminal to thereby provide free space in a memory of the terminal;
transferring installation data for the operation program to the terminal and installing the operation program on the terminal if the operation program is determined to be legal; and
restoring the backed-up information onto the terminal after the operation program is loaded and installed on the terminal.

3. The method of claim 2, wherein the memory comprises a nonvolatile memory.

4. The method of claim 1, wherein determining whether or not the operation program is legal comprises:
comparing a protection code stored in a download program for downloading the operation program to the terminal and a protection code stored in the operation program.

5. The method of claim 4, wherein if the protection code of the download program and the protection code of the operation program are the same, the loading of the operation program is determined to be legal.

6. The method of claim 4, wherein if the protection code of the download program and the protection code of the operation program are not the same, the loading of the operation program is determined to be illegal.

7. The method of claim 1, further comprising:
stopping the loading operation if the loading of the operation program is determined to be illegal.

8. The method of claim 1, wherein the operation program is from a mobile communications provide and is used to operate the mobile terminal.

9. A system for loading an operation program onto a mobile terminal, comprising:
a determining unit configured to determine whether or not a loading operation for loading an operation program onto the mobile terminal is legal.

10. The system of claim 9, further comprising:
a backing-up unit configured to back-up operation program related information originally stored on the terminal to thereby provide free space in a memory of the terminal;
a transferring unit configured to transfer installation data for the operation program to the terminal and to install the operation program on the terminal if the operation program is determined to be legal; and
a restoring unit configured to restore the backed-up information onto the terminal after the operation program is loaded and installed on the terminal.

11. The system of claim 10, wherein the memory comprises a nonvolatile memory.

12. The system of claim 9, wherein the determining unit determines whether or not the operation program is legal by comparing a protection code stored in a download program for downloading the operation program to the terminal and a protection code stored in the operation program.

13. The system of claim 12, wherein if the protection code of the download program and the protection code of the operation program are the same, the loading of the operation program is determined to be legal.

14. The system of claim 12, wherein if the protection code of the download program and the protection code of the operation program are not the same, the loading of the operation program is determined to be illegal.

15. The system of claim 9, wherein the loading operation is stopped if the loading of the operation program is determined to be illegal.

16. The system of claim 9, wherein the operation program is from a mobile communications provider and is used to operate the mobile terminal.

17. A method for loading an operation program onto a mobile terminal, comprising:
comparing a first security code of the operation program for operating the mobile terminal with a second security code of a downloading program used for downloading the operation program onto the mobile terminal; and
determining whether or not a loading operation for loading the operation program onto the mobile terminal is legal based on the comparison of the first and second security codes.

18. The method of claim 17, wherein the loading operation is determined to be illegal if the first and second security codes do not match, and the loading operation is halted.

19. The method of claim 17, wherein the loading operation is determined to be legal if the first and second security codes match, and the operation program is loaded onto the mobile terminal.

20. The method of claim 17, further comprising:
saving original operation program related information that is on the mobile terminal before the operation program is installed and then restoring the operation program related information onto the mobile terminal after the operation program is loaded and installed onto the mobile terminal.

21. The method of claim 17, wherein the operation program is from a communications company and is used to operate the terminal.
